(19) United States
(12) Patent Application Publication
(10) Pub. No.: US 2008/0178399 A1
(43) Pub. Date: Jul. 31, 2008

(54) Method and Kit for Coloring Hair

(76) Inventors: Lou Ann Christine Vena, Scotch Plains, NJ (US); Philip Franco, Ocean Grove, NJ (US)

Correspondence Address: Julie Blackburn;Revlon Consumer Products Corporation, Law Department, 237 Park Avenue, New York, NY, 10017, US

(21) Appl. No.: 11/668,132

(22) Filed: Jan. 29, 2007

(51) Int. Cl. A61Q 5/10

(52) U.S. Cl. 8/407

(57) ABSTRACT

A kit for oxidatively coloring hair comprising at least one receptacle containing an oxidative dye composition, at least one receptacle containing a developer composition, and at least one receptacle containing an aqueous based diluent composition; and a method for coloring hair by applying a portion of the oxidative dye mixture formed by combining the oxidative dye composition and the developer to the hair for a certain period of time followed by diluting the remaining portion of the oxidative dye mixture and applying it to the entire head of hair.

### TECHNICAL FIELD

This invention is in the field of methods and kits for improved oxidative coloration of hair.

### BACKGROUND OF THE INVENTION

A significant percentage of oxidative hair color users are consumers with gray hair who wish to cover the gray. However, there are certain problems encountered when oxidatively coloring gray hair, particularly when performing regular maintenance oxidative coloring to color virgin roots that have grown out. In this situation, the hair that is to be colored has new gray hair growth at the roots, with the remaining portion of the hair exhibiting the color that was applied in the prior coloring session. Another subset of consumers who oxidatively color their hair generally start with one hair color and dye their hair another color that is distinctly different. As the hair grows out, the difference in color between the virgin hair roots and remaining hair is noticeable.

In any oxidative hair dyeing procedure the resulting hair color, to some extent, depends on the color of the base hair shade. When the consumer has a mixture of colors as the base hair shade, e.g. 50% gray hair and 50% virgin color, or virgin gray roots with the remaining hair colored, or roots and remaining hair with two visually distinct colors, the oxidative dye will tend to provide a noticeably different color on the differently colored strands. In the ease where the consumer oxidatively colors her hair every six to eight weeks to treat gray roots, there can be a noticeable color difference between the dyed roots and ends of the hair after the oxidative color procedure. This is obviously undesirable. In the case where the consumer oxidatively colors her hair to provide a dramatic color difference, any visually perceptible difference in color after the maintenance oxidative dye process is undesirable.

Companies that sell oxidative hair color have tried to address the problem for consumers who dye their hair to treat gray in a variety of ways. For example, Clairol sells a product called Grey Solutions™ designed specifically for oxidative hair color users that are coloring gray hair. In this Clairol product the user first pre-treats the hair with a conditioner composition that absorbs into the hair and provides a uniform surface for color deposit. Thus, when the oxidative dye mixture is applied to the hair it will color the hair evenly, whether the hair is gray or colored. In order to ensure that the gray hairs are adequately colored, the Clairol product has a greater than normal concentration of oxidative dye. While the extra dye concentration will result in gray hair roots that are adequately colored, it also creates a banding effect where the dyed gray hair is lighter than the dyed non-gray hair after the oxidative dye procedure.

When hair is colored by professionals in the salon environment, the banding is ameliorated in a variety of different ways. In one situation the oxidative color is first applied to the roots of the hair for an appropriate period of time. Some of the oxidative dye mixture is held aside. Then, during the last portion of the coloring process the remaining oxidative dye mixture is applied to the entire head of hair. For example, in the typical salon setting the majority of the oxidative dye mixture is applied to the hair roots for about 30 minutes. Then the remaining oxidative dye mixture is applied to the entire head of hair for about 5 minutes. Another salon method is to treat the roots of the hair with the full strength oxidative dye composition for the desired period of time, then apply a diluted mixture of oxidative dye to the remaining portion of the hair. In either case, the hair roots, having one color, have a longer exposure to the oxidative dye mixture and will, in general, exhibit color that is closer to the strands that were subjected to the oxidative dye mixture for only 5 minutes. These salon processes have drawbacks. For example, applying the oxidative dye composition to the remaining hair after treatment of the roots for the appropriate period of time may cause the dye composition to overly deposit or “grab” on the hair strands. In general, the dye composition tends to grab more on hair that is damaged or porous. This provides uneven color deposition on the hair.

The at-home hair color user typically doesn't have the skill to do many of the hair coloring processes that take place in the salon environment. This is particularly true when coloring hair in stages, where only a portion of the color is applied to the roots. It requires a certain degree of skill to apply the color to just the root area, to know how much to apply and when, and ensure that the subsequent application of dye composition to the entire head of hair will provide a uniform color from root to tip with no grabbing or otherwise damaging of the hair ends.

Accordingly, there is a need for a retail hair color kit and method that will enable the consumer who colors her hair at home to obtain salon quality oxidative hair color on gray hair or hair that exhibits two or more visually perceptible colors.

It is an object of the invention to provide an oxidative hair color kit for retail consumers who have gray hair and wish to obtain uniform, natural coloration to virgin hair and hair that is subjected to regular oxidative hair color procedures.

It is a further object of the invention to provide an oxidative hair color kit for retail consumers who wish to oxidatively color gray hair and virgin hair and obtain hair coloration that does not vary depending on the color of the base hair shade.

It is a further object of the invention to provide an oxidative hair color kit for retail consumers who have natural hair that exhibits one distinctive color and colored hair that exhibits a second distinctive color.

It is a further object of the invention to provide a method for coloring hair that has at least some gray by treating the hair in steps by applying a first portion of oxidative dye composition to the hair roots and/or faded or discolored strands of hair for a certain period of time, then applying a second diluted portion of oxidative dye composition to the remaining hair for a second additional period of time.

It is a further object of the invention to provide a kit and method for oxidatively coloring hair that has at least two visually perceptible different colors where the method provides hair that is uniformly and naturally colored.

It is a further object of the invention to provide a kit and method for coloring hair that provides uniform color from root to tip and does not grab, or over deposit, on damaged hair ends.

It is a further object of the invention to provide a method and kit for coloring hair that provides uniform and true coloration no matter what the base hair shade is, and particularly when the base hair shade has two visually perceptible different colors.

It is a further object of the invention to provide a method and kit for coloring hair that provides an easier application of oxidative dye composition to the root area, and, subsequently, the entire head of hair.

### SUMMARY OF THE INVENTION

The invention comprises a kit for oxidatively coloring hair comprising at least one receptacle containing an oxidative dye composition, at least one receptacle containing a developer composition, wherein the oxidative dye composition and the developer are mixed to form an oxidative dye mixture, and at least one receptacle containing an aqueous based diluent for the oxidative dye mixture.

The invention further comprises a method for oxidatively coloring hair that exhibits at least two visually perceptible different colors with one such color being exhibited by virgin hair, comprising:

(a) combining an oxidative dye composition and a developer composition to form an oxidative dye mixture,

(b) applying a portion of the dye mixture selectively to the virgin hair for a certain period of time,

(c) diluting the remaining portion of the oxidative dye mixture with an aqueous based diluent to form a diluted oxidative dye mixture,

(d) applying the diluted oxidative dye mixture to the remaining hair for a certain period of time.

### BRIEF DESCRIPTION OF DRAWINGS

FIG. 1 depicts a retail oxidative hair color kit in accordance with the invention and the various components that may be found in the kit.

### DETAILED DESCRIPTION

### I. The Kit

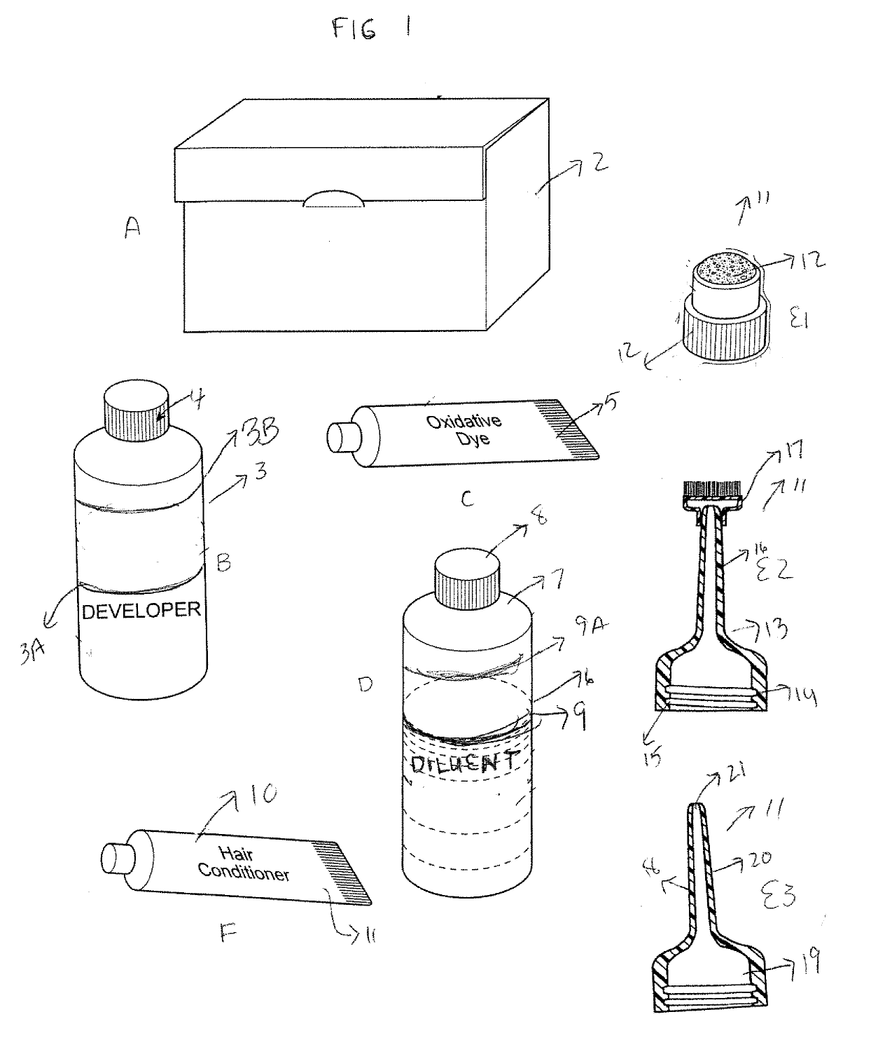

The kit of the invention and the various items that may be found in the kit is depicted in FIG. 1.

A. Kit Container

The kit generally comprises a container 2 for holding the various items in the kit 1. The container 2 may be a carton, possibly made from cardboard, paper, or thermoplastic material. The container 2 typically is printed with graphics and indicia. Graphics may include model photographs, a color swatch depicting the type of oxidative hair color to be found therein, and so on. The container may also contain an ingredient listing of all the compositions found within the various receptacles, a list of items found within the kit, manufacturer source information, UPC codes, and so on.

In most preferred embodiments, the container is made from paper or cardboard, and imprinted with graphics and indicia as desired by the manufacturer.

B. Developer

1. The Receptacle for the Developer

The kit 1 contains a developer composition 3. The term “developer” means an aqueous based oxidizing agent composition that, when combined with the oxidative dye composition, activates the oxidative dye composition to form a composition that is operable to oxidatively color hair. The developer composition 3 is most often found in a bottle B that is made of a thermoplastic material such as high density polyethylene or the like. The bottle B must be made of a material that provides adequate barrier properties for the developer composition 3, which is acidic and may corrode thermoplastics that do not exhibit adequate barrier properties.

The bottle B contains a closure 4. A screw cap 4 is one type of closure that is appropriate. The screw cap 4 has threads on the inner surface of the cap 4 that mate with similar threads found on the outer neck of the bottle B.

In one embodiment of the invention, developer bottle B contains indicator lines 3A and/or 3B. In this case, the oxidative dye mixture that is applied to hair is obtained by combining the oxidative dye composition and the developer composition. This is done by adding the oxidative dye composition to the developer bottle B. As further described herein, when the user performs the first step of the oxidative coloring procedure of the invention, the user applies a portion of the oxidative dye mixture formed in this way to the desired sections of the hair, e.g. the new hair growth at the roots, or the faded or discolored strands of hair. Indicator line 3B shows the consumer that the portion of the total oxidative dye mixture that should be used for the first step is an amount removed from the developer bottle B so that the level of the oxidative dye mixture reaches indicator line 3A.

Indicator line 3B is present to indicate to the user how much of the diluent (further described below) is added to the developer receptacle B to dilute the remaining oxidative dye mixture for application to the hair.

2. The Developer Composition

The developer composition comprises a certain ratio of water phase, oil phase, and an aqueous based oxidizing agent such as urea peroxide or hydrogen peroxide.

(a). Water

The developer composition comprises from about 1 to 90%, preferably from about 5 to 85%, more preferably from about 10-80% by weight of the total composition of water. In one preferred embodiment the developer composition comprises greater than about 75%, more preferably greater than about 77% by weight of the total composition of water phase.

(b). Humectants

The developer composition may contain one or more humectants. If present, such humectants may range from about 0.01-25%., preferably about 0.05-15%, more preferably about 0.1-10% by weight of the total composition. Suitable humectants include mono-, di-, or polyhydric alcohols, and similar water soluble ingredients. Examples of such humectants include propylene glycol, butylene glycol, glycerin and sugars such as glucose, fructose, mannose, mannitol, malitol, lactitol, and the like.

(c). Chelating Agents

The developer composition may contain one or more chelating agents which are capable of complexing with, and inactivating, metallic ions in order to prevent their adverse effects on the stability or effects of the composition. If present, suggested ranges are from about 0.0001-5%, preferably 0.0005-3%, more preferably 0.001-2% by weight of the total developer composition. Suitable chelating agents include EDTA and calcium, sodium, or potassium derivatives thereof, HEDTA, sodium citrate, TEA-EDTA, and so on.

(d). pH Adjusters

It may also be desireable to add small amounts of acids or bases to adjust the pH of the developer composition to the desired pH range of about 3.0 to 5.0, more preferably about 3.4 to 4.2. Suitable acids include hydrochloric acid, phosphoric acid, erythorbic acid, and the like. Suitable bases include sodium hydroxide, potassium hydroxide, disodium phosphate, and the like. Also suitable are primary, secondary, or tertiary amines or derivative thereof such as aminomethyl propanol, monoethanolamine, and the like. Suggested ranges of pH adjusters are from about 0.00001-8%, preferably about 0.00005-6%, more preferably about 0.0001-5% by weight of the total composition.

(e). Oil Ingredients

Although it is not necessary, the developer may comprise from about 15 to 80%, preferably from about 20-75%, more preferably from about 25 to 65% by weight of the total developer composition of one or more oily ingredients. The term “oily ingredients” means ingredients that are soluble in the oil phase, or form part of the oil phase when the composition is in the emulsion form. The oily ingredients preferably have a conditioning benefit, e.g. will improve the condition of the hair whether used alone or in combination with other oil phase ingredients. Suitable oily ingredients include animal, vegetable, mineral, or synthetic oils, polymers, and so on.

If present, one or more of the oils may be hydrophobic in character. The term “hydrophobic” generally means that such oil has a Hildebrand solubility parameter (δ) measured in (cal/cm³)^{1/2} (the square root of calories per cubic centimeter), ranging from about 5 to 12, preferably from about 7 to 9. The term “hydrophobic” means that the oil is lipophilic in character. If present, the hydrophobic oil is preferably a liquid at room temperature (25° C.).

The term “solubility parameter” when used herein means the Hildebrand solubility parameter (δ) which is calculated according to the formula:

δ=(ΔEv/V)^{1/2}

wherein ΔEv=heat of vaporization of the particular ingredient, and V=molecular weight/density of the ingredient.

The Hildebrand solubility parameters (δ) are generally available by referring to standard chemistry textbooks or similar reference manuals. The Journal of the Society of Cosmetic Chemistry, Volume 36, pages 319-333, and Cosmetics and Toiletries, Vol. 103, October 1988, pages 47-69, both of which are hereby incorporated by reference in their entirety, list the Hildebrand solubility parameter (δ) values for a wide variety of cosmetic ingredients and how the solubility parameter is calculated.

Oils which have solubility parameters which are significantly less than 5 are extremely hydrophobic, and while such oils may promote preferential absorption of the active ingredients into the hair shaft by causing the water soluble actives to “repel” the oil and be preferentially pushed into the hair shaft, they are difficult to disperse in the developer composition because of their extreme lipophilic character. Oils which have Hildebrand solubility parameters that are significantly greater than 12 are too hydrophilic and will more readily form part of the water phase of the emulsion developer composition. Accordingly, such oils will not induce preferential absorption of the water soluble active ingredients into the hair shaft as such active ingredients are compatible with the hydrophilic ingredients present in the composition.

(i). Vegetable Oils

Suitable vegetable oils include those derived from plants such as leaves, stems, bark, flowers, fruit, etc. Examples include oils from coconut, grape seed, grape, apple seed, coconut oil, linseed oil, safflower, corn, poppy seed, corn, currant, peanut, almond, cotton seed, birch, pine seed, pine nut, and so on. Preferred is coconut oil.

(ii). Hydrocarbons

Suitable hydrocarbons include mineral oil, squalane, squalene, polybutene, polyisobutene, polydecene, and hydrogenated derivatives thereof. Also preferred is mineral oil.

(iii). Cationic Silicones

As used herein, the term “cationic silicone” means any silicone polymer or oligomer having a silicon backbone, including polysiloxanes, having a positive charge on the silicone structure itself. Cationic silicones that may be used in the developer compositions of the invention include those corresponding to the following formula, where the ratio of D to T units, if present, are greater than about 80 D units to 1 T unit:

(R)ₐG₃₋ₐ-Si—(—OSiG₂)ₙ-(-OSiG_{b}(R₁)_{2-6b})ₘ—O—SiG₃₋ₐ(R₁)ₐ

in which G is selected from the group consisting of H, phenyl, OH, C₁₋₁₀ alkyl, and is preferably CH₃; and a is 0 or an integer from 1 to 3, and is preferably 0; b is 0 or 1, preferably 1; the sum n+m is a number from 1 to 2,000 and is preferably 50 to 150; n is a number from 0 to 2000, and is preferably 50 to 150; and m is an integer from 1 to 2000, and is preferably 1 to 10; R is a C₁₋₁₀ alkyl, and R₁ is a monovalent radical of the formula C_{q}H_{2q}L in which q is an integer from 2 to 8 and L is selected from the groups:

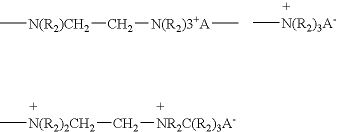

in which R₂ is selected from the group consisting of H, phenyl, benzyl, a saturated hydrocarbon radical, and is preferably an alkyl radical containing 1-20 carbon atoms; and A- is a halide, methylsulfate, or tosylate ion.

(iv). Nonionic Silicones

Also suitable as conditioning agents are one or more silicones. Suitable silicone hair conditioning agents include volatile or nonvolatile nonionic silicone fluids, silicone resins, and silicone semi-solids or solids.

Volatile silicones are linear or cyclic silicones having a measureable vapor pressure, which is defined as a vapor pressure of at least 2 mm. of mercury at 20° C. Examples of volatile silicones are cyclic silicones having the general formula:

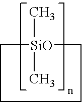

where n=3-7.

Also, linear volatile silicones that may be used in the compositions of the invention have the general formula:

(CH₃)₃Si—O—[Si(CH₃)₂—O]ₙ—Si(CH₃)₃

where n=0-7, preferably 0-5.

Also suitable are nonvolatile silicone fluids including polyalkyl siloxanes, polyaryl siloxanes, polyalkylaryl siloxanes, polyether siloxane copolymers, amine-functional silicones, and mixtures thereof. Such silicones have the following general formula:

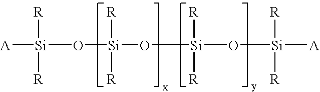

wherein R and R′ are each independently alkyl, aryl, or an alkyl substituted with one or more amino groups, and x and y are each independently 0-100,000, with the proviso that x+y equals at least one, and A is siloxy endcap unit. Preferred is where A is methyl, R is methyl, and R′ is an alkyl substituted with at least two amino groups, most preferably an amine-functional silicone having the formula:

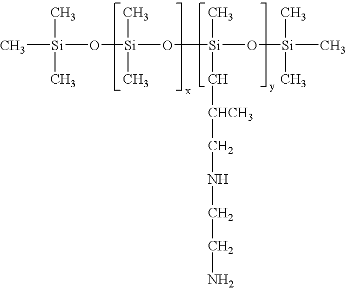

which is known by the CTFA name trimethylsilylamodimethicone.

Another type of silicone conditioning agent is a silicone polymer having the following general formula:

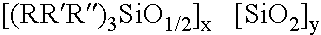

wherein R, R′ and R″ are each independently a C₁₋₁₀ straight or branched chain alkyl or phenyl, and x and y are such that the ratio of (RR′R″)₃SiO_{1/2} units to SiO₂ units is 0.5 to 1 to 1.5 to 1. Preferably R, R′ and R″ are a C₁₋₆ alkyl, and more preferably are methyl and x and y are such that the ratio of (CH₃)₃SiO_{1/2} units to SiO₂ units is 0.75 to 1. Most preferred is this trimethylsiloxy silicate containing 2.4 to 2.9 weight percent hydroxyl groups, which is formed by the reaction of the sodium salt of silicic acid, chlorotrimethylsilane, and isopropyl alcohol. The manufacture of trimethylsiloxy silicate is set forth in U.S. Pat. Nos. 2,676,182; 3,541,205; and 3,836,437, all of which are hereby incorporated by reference. Trimethylsiloxysilicate as described is available from Dow Corning Corporation under the tradename Dow Corning 749 Fluid, which is a blend of about 40-60% volatile silicone and 40-60% trimethylsiloxy silicate (trimethylated silica). The fluid has a viscosity of 200-700 centipoise at 25° C., a specific gravity of 1.00 to 1.10 at 25° C., and a refractive index of 1.40-1.41.

(g). Lipophilic Polymers

A variety of lipophilic polymers are suitable for use in the developer composition, including copolymers of vinylpyrrolidone, polymers of dimethyldiallyl ammonium chloride, acrylic or methacrylic polymers, quaternary ammonium polymers, and the like.

(i). Copolymers of Vinylpyrrolidone

Copolymers of vinylpyrrolidone having monomer units of the formula:

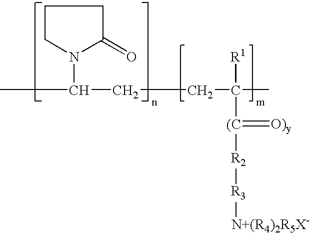

wherein R¹ is hydrogen or methyl, preferably methyl;

y is 0 or 1, preferably 1

R² is O or NH, preferably NH;

R³ is CₓH₂ₓ where x is 2 to 18, or —CH₂—CHOH—CH₂, preferably CₓH₂ₓ where x is 2;

R⁴ is methyl, ethyl, phenyl, or C₁₋₄ substituted phenyl, preferably methyl; and

R⁵ is methyl or ethyl, preferably methyl.

(ii). Polymers of Dimethyldiallylammonium Chloride

Homopolymers of dimethyldiallylammonium chloride or copolymers of dimethyldiallylammonium chloride and acrylamide are also suitable. Such compounds are sold under the tradename MERQUAT by Calgon.

(iii). Acrylic or Methacrylic Acid Polymers

Homopolymers or copolymers derived from acrylic or methacrylic acid, selected from monomer units acrylamide, methylacrylamide, diacetone-acrylamide, acrylamide or methacrylamide substituted on the nitrogen by lower alkyl, alkyl esters of acrylic acid and methacrylic acid, vinylpyrrolidone, or vinyl esters are suitable for use.

(h). Thickeners

The developer composition may contain one or more thickeners that assist in maintaining an increased viscosity of the final composition resulting from mixture of the hair dye composition and the developer composition. The amount of thickening agent if present is about 0.001-5%, preferably about 0.005-4%, more preferably about 0.005-3% by weight of the total composition.

A variety of thickening agents are suitable including low melting point waxes, carboxyvinyl polymers, and the like. Also suitable are a variety of water soluble anionic thickening polymers such as those disclosed in U.S. Pat. No. 4,240,450, which is hereby incorporated by reference. Suggested ranges of such polymers are about 0.01-5%, preferably 0.05-4%, more preferably 0.1-3% by weight of the total developer composition. Examples of such anionic polymers are copolymers of vinyl acetate and crotonic acid, graft copolymers of vinyl esters or acrylic or methacrylic acid esters, cross-linked graft copolymers resulting from the polymerization of at least one monomer of the ionic type, at least one monomer of the nonionic type, polyethylene glycol, and a crosslinking agent, and the like. Preferred are acrylate copolymers such as steareth-10 allyl ether acrylate copolymer.

(i). Nonionic Surfactants

The developer composition may contain one or more nonionic surfactants. Suggested ranges of nonionic surfactant, if present, are about 0.01-10%, preferably about 0.05-8%, more preferably about 0.1-7% by weight of the total composition. Suitable nonionic surfactants include alkoxylated alcohols or ethers, alkoxylated carboxylic acids, sorbitan derivatives, and the like.

(i). Alkoxylated Alcohols

Suitable alkoxylated alcohols, or ethers, are formed by the reaction of an alcohol with an alkylene oxide, usually ethylene or propylene oxide. Preferably the alcohol is a fatty alcohol having 6 to 30 carbon atoms, and a straight or branched, saturated or unsaturated carbon chain. Examples of such ingredients include steareth 2-30, which is formed by the reaction of stearyl alcohol and ethylene oxide where the number of repeating ethylene oxide units is 2 to 30; Oleth 2-30 which is formed by the reaction of oleyl alcohol and ethylene oxide where the number of repeating ethylene oxide units is 2 to 30; Ceteareth 2-100, formed by the reaction of a mixture of cetyl and stearyl alcohol with ethylene oxide, where the number of repeating ethylene oxide units in the molecule is 2 to 100; Ceteth 1-45 which is formed by the reaction of cetyl alcohol and ethylene oxide, and the number of repeating ethylene oxide units is 1 to 45, and so on. Particularly preferred are Steareth-21, which is the reaction product of a mixture of stearyl alcohol with ethylene oxide, and the number of repeating ethylene oxide units in the molecule is 21, and Oleth-20 which is the reaction product of oleyl alcohol and ethylene oxide wherein the number of repeating ethylene oxide units in the molecule is 20.

(ii). Alkoxylated Carboxylic Acids

Also suitable as the nonionic surfactant are alkyoxylated carboxylic acids, which are formed by the reaction of a carboxylic acid with an alkylene oxide or with a polymeric ether. The resulting products have the general formula:

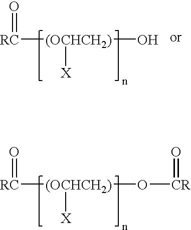

where RCO is the carboxylic ester radical, X is hydrogen or lower alkyl, and n is the number of polymerized alkoxy groups. In the case of the diesters, the two RCO— groups do not need to be identical. Preferably, R is a C₆₋₃₀ straight or branched chain, saturated or unsaturated alkyl, and n is from 1-100.

(iii). Alkoxylated Sorbitans

Also suitable are various types of alkoxylated sorbitan and alkoxylated sorbitan derivatives. For example, alkoxylation, in particular, ethoxylation, of sorbitan provides polyalkoxylated sorbitan derivatives. Esterification of polyalkoxylated sorbitan provides sorbitan esters such as the polysorbates. Examples of such ingredients include Polysorbates 20-85, sorbitan oleate, sorbitan palmitate, sorbitan sesquiisostearate, sorbitan stearate, and so on.

(j). Anionic Surfactants

If desired the developer composition may contain one or more anionic surfactants. Preferred ranges of anionic surfactant, if present, are from about 0.1-25%, preferably 0.5-20%, more preferably 1-15% by weight of the total composition. Suitable anionic surfactants include alkyl and alkyl ether sulfates generally having the formula ROSO₃M and RO(C₂H₄O)ₓSO₃M wherein K is alkyl or alkenyl of from about 10 to 20 carbon atoms, x is 1 to about 10 and M is a water soluble cation such as ammonium, sodium potassium, or triethanolamine cation.

Another type of anionic surfactant which may be used in the compositions of the invention are water soluble salts of organic, sulfuric acid reaction products of the general formula:

R₁—SO₃-M

wherein R₁ is chosen from the group consisting of a straight or branched chain, saturated aliphatic hydrocarbon radical having from about 8 to about 24 carbon atoms, preferably 12 to about 18 carbon atoms; and M is a cation. Examples of such anionic surfactants are salts of organic sulfuric acid reaction products of hydrocarbons such as n-paraffins having 8 to 24 carbon atoms, and a sulfonating agent, such as sulfur trioxide.

Also suitable as anionic surfactants are reaction products of fatty acids esterified with isethionic acid and neutralized with sodium hydroxide. The fatty acids may be derived from coconut oil, for example.

Other suitable anionic surfactants include olefin sulfonates having about 12 to 24 carbon atoms. The term “olefin sulfonate” means a compound that can be produced by sulfonation of an alpha olefin by means of uncomplexed sulfur trioxide, followed by neutralization of the acid reaction mixture in conditions such that any sultones which have been formed in the reaction are hydrolyzed to give the corresponding hydroxy-alkanesulfonates. The alpha-olefin from which the olefin sulfonate is derived is a mono-olefin having about 12 to 24 carbon atoms, preferably about 14 to 16 carbon atoms.

Other classes of suitable anionic organic surfactants are the beta-alkoxy alkane sulfonates or water soluble soaps thereof such as the salts of C₁₀₋₂₀ fatty acids, for example coconut and tallow based soaps. Preferred salts are ammonium, potassium, and sodium salts.

Still another class of anionic surfactants include N-acyl amino acid surfactants and salts thereof (alkali, alkaline earth, and ammonium salts) having the formula:

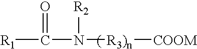

wherein R₁ is a C₈₋₂₄ alkyl or alkenyl radical, preferably C₁₀₋₁₈; R₂ is H, C₁₋₄ alkyl, phenyl, or —CH₂COOM; R₃ is CX₂— or C₁₋₂ alkoxy, wherein each X independently is H or a C₁₋₆ alkyl or alkylester, n is from 1 to 4, and M is H or a salt forming cation as described above. Examples of such surfactants are the N-acyl sarcosinates, including lauroyl sarcosinate, myristoyl sarcosinate, cocoyl sarcosinate, and oleoyl sarcosinate, preferably in sodium or potassium forms

(j). Amphoteric or Zwitterionic Surfactants

Also suitable are amphoteric and zwitterionic surfactants. Examples of amphoteric surfactants that can be used in the compositions of the invention are generally described as derivatives of aliphatic secondary or tertiary amines wherein one aliphatic radical is a straight or branched chain alkyl of 8 to 18 carbon atoms and the other aliphatic radical contains an anionic group such as carboxy, sulfonate, sulfate, phosphate, or phosphonate.

(k). Fatty Alcohols

The developer composition may also contain one or more fatty alcohols of the general formula R—OH wherein R is a C₆₋₄₀ straight or branched chain, saturated or unsaturated alkyl. Preferred alcohols include cetearyl alcohol, stearyl alcohol, cetyl alcohol, and the like. If present the fatty alcohol may range from about 0.1-10%, preferably from about 0.5-8%, more preferably from about 1-7% by weight of the total composition.

The developer composition may contain one or more additional ingredients including but not limited to botanicals, antioxidants, polymers, pigments, and the like.

The preferred developer compositions of the invention have a concentration of hydrogen peroxide ranging from about 2 to 8% by weight of the total oil phase and 1 to 5% by weight of the total composition and wherein the ratio of water to oil phase ranges from about 1.5 to 5 parts water phase to 1 part oil phase. In the tables below, the concentration of hydrogen peroxide in developer compositions ranging from 5 to 30 Volume are set forth, both by weight of the total composition. The developer compositions used in the method of the invention include those having 5 to 15 Volumes of hydrogen peroxide.

| Hydrogen Peroxide | |
|---|---|
| Composition Volume | Hydrogen Peroxide |
| Concentration - Total | Concentration % by Weight |
| Composition | Total Composition |
| 5 | 1.5 |
| 10 | 3 |
| 15 | 4.5 |
| 20 | 6 |
| 25 | 7.5 |
| 30 | 9 |

If desired the developer composition may be in the form of a microemulsion or liquid crystalline format, as set forth in U.S. Pat. Nos. 6,315,989 and 6,238,653, both of which are hereby incorporated by reference in their entirety. In the case where the developer composition is in the microemulsion form, the dispersed water droplets have particle sizes ranging from 100 to 1500 Angstroms. In the case where the developer composition is in the form of a liquid crystalline composition, the composition contains water, oil, and an appropriate amount of an amphiphilic surface active material that is operable to form liquid crystals.

Preferably, the developer composition is in the form of a water-in-oil or oil-in-water microemulsion having dispersed water microdroplets in the oil phase.

C. Oxidative Dye Composition

1. The Receptacle

The kit contains an oxidative dye composition found in a receptacle 5. While a tube 5 is depicted, the oxidative dye composition may be found in a variety of other receptacles such as bottles, jars, packettes, etc.

2. The Oxidative Dye Composition

In general, the oxidative dye compositions are aqueous based and comprise about 0-20%. preferably about 0.001-10%, more preferably about 0.01-8% by weight of the total oxidative dye composition of dyestuff components and about 0.0001-99.9%, preferably about 0.001-98%, more preferably about 0.001-90% by weight of the total composition of a water base.

(a). Dyestuff Components

Dyestuff components include primary intermediates and, optionally, couplers for the formation of oxidation dyes.

Suggested ranges of primary intermediates present in the oxidative dye composition range from about 0-6%, preferably about 0.0001-5.5%, more preferably about 0.001-5% by weight of the total composition. Such primary intermediates are well known for use in hair color, and include ortho or para substituted aminophenols or phenylenediamines, such as para-phenylenediamines of the formula:

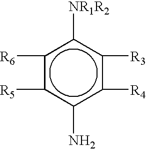

wherein R₁ and R₂ are each independently hydrogen, C₁₋₆ alkyl, or C₁₋₆ alkyl substituted with one or more hydroxy, methoxy, methylsulphonylamino, aminocarbonyl, furfuryl, unsubstituted phenyl, or amino substituted phenyl groups; R₃, R₄, R₅, and R₆ are each independently hydrogen, C₁₋₆ alkyl, C₁₋₆ alkoxy, halogen, or C₁₋₆ alkyl substituted with one or more hydroxy or amino groups.

Specific examples of suitable primary intermediates include para-phenylenediamine, 2-methyl-1,4-diaminobenzene, 2,6-dimethyl-1,4-diaminobenzene, 2,5-dimethyl-1,4-diaminobenzene, 2,3-dimethyl-1,4-diaminobenzene, 2-chloro-1,4-diaminobenzene, 2-methoxy-1,4-diaminobenzene, 1-phenylamino-4-aminobenzene, 1-dimethylamino-4-aminobenzene, 1-diethylamino-4-aminobenzene, 1-bis(beta-hydroxyethyl)amino-4-aminobenzene, 1-methoxyethylamino-4-aminobenzene, 2-hydroxymethyl-1,4-diaminobenzene, 2-hydroxyethyl-1,4-diaminobenzene, 2-isopropyl-1,4-diaminobenzene, 1-hydroxypropylamino-4-aminobenzene, 2,6-dimethyl-3-methoxy-1,4-diaminobenzene, 1-amino-4-hydroxybenzene, and derivatives thereof, and acid or basic salts thereof.

Preferred primary intermediates are p-phenylenediamine, p-aminophenol, o-aminophenol, N,N-bis(2-hydroxyethyl)-p-phenylenediamine, 2,5-diaminotoluene, their salts and mixtures thereof.

Suitable color couplers, if present, range from about 0.0001-10%, more preferably about 0.0005-8%, most preferably about 0.001-7% by weight of the total oxidative dye composition. Such color couplers include, for example, those having the general formula:

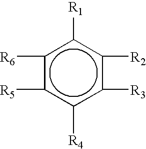

wherein R₁ is unsubstituted hydroxy or amino, or hydroxy or amino substituted with one or more C₁₋₆ hydroxyalkyl groups, R₃ and R₅ are each independently hydrogen, hydroxy, amino, or amino substituted with C₁₋₆ alkyl, C₁₋₆ alkoxy, or C₁₋₆ hydroxyalkyl group; and R₂, R₄, and R₆ are each independently hydrogen, C₁₋₆ alkoxy, C₁₋₆ hydroxyalkyl, or C₁₋₆ alkyl, or R₃ and R₄ together may form a methylenedioxy or ethylenedioxy group. Examples of such compounds include meta-derivatives such as phenols, catechol, meta-aminophenols, meta-phenylenediamines, and the like, which may be unsubstituted, or substituted on the amino group or benzene ring with alkyl, hydroxyalkyl, alkylamino groups, and the like. Suitable couplers include m-aminophenol, 2,4-diaminotoluene, 4-amino, 2-hydroxytoluene, phenyl methyl pyrazolone, 3,4-methylenedioxyphenol, 3,4-methylenedioxy-1-[(beta-hydroxyethyl)amino]benzene, 1-methoxy-2-amino-4-[(beta-hydroxyethyl)amino]benzene, 1-hydroxy-3-(dimethylamino)benzene, 6-methyl-1-hydroxy-3[(beta-hydroxyethyl)amino]benzene, 2,4-dichloro-1-hydroxy-3-aminobenzene, 1-hydroxy-3-(diethylamino)benzene, 1-hydroxy-2-methyl-3-aminobenzene, 2-chloro-6-methyl-1-hydroxy-3-aminobenzene, 1,3-diaminobenzene, 6-methoxy-1,3-diaminobenzene, 6-hydroxyethoxy-1,3-diaminobenzene, 6-methoxy-5-ethyl-1,3-diaminobenzene, 6-ethoxy-1,3-diaminobenzene, 1-bis(beta-hydroxyethyl)amino-3-aminobenzene, 2-methyl-1,3-diaminobenzene, 6-methoxy-1-amino-3-[(beta-hydroxyethyl)amino]-benzene, 6-(beta-aminoethoxy)-1,3-diaminobenzene, 6-(beta-hydroxyethoxy)-1-amino-3-(methylamino)benzene, 6-carboxymethoxy-1,3-diaminobenzene, 6-ethoxy-1-bis(beta-hydroxyethyl)amino-3-aminobenzene, 6-hydroxyethyl-1,3-diaminobenzene, 1-hydroxy-2-isopropyl-5-methylbenzene, 1,3-dihydroxybenzene, 2-chloro-1,3-dihydroxybenzene, 2-methyl-1,3-dihydroxybenzene, 4-chloro-1,3-dihydroxybenzene, 5,6-dichloro-2-methyl-1,3-dihydroxybenzene, 1-hydroxy-3-amino-benzene, 1-hydroxy-3-(carbamoylmethylamino)benzene, 6-hydroxybenzomorpholine, 4-methyl-2,6-dihydroxypyridine, 2,6-dihydroxypyridine, 2,6-diaminopyridine, 6-aminobenzomorpholine, 1-phenyl-3-methyl-5-pyrazolone, 1-hydroxynaphthalene, 1,7-dihydroxynaphthalene, 1,5-dihydroxynaphthalene, 5-amino-2-methyl phenol, 4-hydroxyindole, 4-hydroxyindoline, 6-hydroxyindole, 6-hydroxyindoline, 2,4-diamionphenoxyethanol, and mixtures thereof.

Preferred couplers include resorcinol, 1-naphthol, 2-methylresorcinol, 4-amino-2-hydroxy toluene, m-aminophenol, 2,4-diamionphenoxyethanol, phenyl methyl pyrazolone, their salts, or mixtures.

In the haircolor industry, haircolor is classified into one of ten levels as follows:

```
  1 = very black
  2 = bright black
  3 = very dark brown
  4 = dark brown
  5 = medium brown
  6 = light brown
  7 = dark blonde
  8 = medium blonde
  9 = light blonde
10 = high lift blonde
```

Set forth in the table below is a non-limiting example of the primary intermediates and the color couplers that may be used in various shades of hair color. Other primary intermediates and couplers may be used in addition to, or in lieu of, those set forth in the Table and nothing herein shall be construed to limit the invention to only those primary intermediates and couplers set forth.

| | | | |
|---|---|---|---|
| Primary | | Primary | |
| Intermediates | Couplers | Intermediates | Couplers |

| Level 1 - Very Black | | Level 2 - Bright Black | |
|---|---|---|---|
| p-phenylenediamine | m-aminophenol | p-phenylenediamine | resorcinol |
| p-phenylenediamine | resorcinol | 2-chloro-P- | |
| sulfate | | phenylenediamine | |
| | | sulfate | |
| 2-chloro-phenylenediamine | 4-amino-2-hydroxytoluene | o-aminophenol | |
| sulfate | | | |
| p-aminophenol | 4-chlororesorcinol | | |
| o-aminophenol | m-aminophenol | | |
| | HCL | | |
| | 2,4-diaminophenoxy | | |
| | ethanol | | |
| | m- | | |
| | phenylenediamine | | |
| | sulfate | | |
| Level 3 - Very Dark Brown | | Level 4 - Dark Brown | |
| p-phenylenediamine | resorcinol | p-phenylenediamine | resorcinol |
| N,N-bis(2-hydroxyethyl)- | 1-naphthol | N,N-bis(2- | 1-naphthol |
| P- | | hydroxyethyl)-P- | |
| phenylenediamine | | phenylene diamine | |
| sulfate | | sulfate | |
| | m-aminophenol | p-aminophenol | m-aminophenol |
| | | | phenyl methyl |
| | | | pyrazolone |
| | | o-aminophenol | 4-amino-2- |
| | | | hydroxytoluene |
| Level 5 - Medium Brown | | Level 6 - Light Brown | |
| p-phenylenediamine | resorcinol | p-phenylenediamine | resorcinol |
| N,N-bis(2-hydroxyethyl)- | 1-naphthol | N,N-bis(2-hydroxyethyl)- | 1-naphthol |
| P-phenylenediamine | | P-phenylenediamine | |
| sulfate | | sulfate | |
| p-aminophenol | m-aminophenol | p-aminophenol | m-aminophenol |
| o-aminophenol | phenyl methyl | | phenyl methyl |
| | pyrazolone | | pyrazolone |
| | 2-methylresorcinol | | 4-amino-2-hydroxytoluene |
| | 4-amino-2-hydrox- | | 2-methylresorcinol |
| | toluene | | |
| Level 7 - Dark Blonde | | Level 8 - Medium Blonde | |
| p-phenylenediamine | resorcinol | p-phenylenediamine | resorcinol |
| N,N-bis(2-hydroxyethyl)- | 1-naphthol | N,N-bis(2- | 1-naphthol |
| P-phenylenediamine | | hydroxyethyl)-P- | |
| sulfate | | phenylenediamine | |
| | | sulfate | |
| p-aminophenol | phenyl methyl | p-aminophenol | m-aminophenol |
| | pyrazolone | | |
| o-aminophenol | | | phenyl methyl |
| | | | pyrazolone |
| | | | 4-amino-2- |
| | | | hydroxytoluene |
| Level 9 - Light Blonde | | Level 10 - High Lift Blonde | |
| p-phenylenediamine | resorcinol | p-phenylenediamine | resorcinol |
| N,N-bis(2- | 4-amino-2-hydroxytoluene | N,N-bis(2-hydroxyethyl)- | 1-naphthol |
| hydroxyethyl)-P- | | P-phenylenediamine | |
| phenylenediamine | | sulfate | |
| sulfate | | | |
| p-aminophenol | phenyl methyl | | phenyl methyl |
| | pyrazolone | | pyrazolone |
| o-aminophenol | 2-methylresorcinol | | 2-methylresorcinol |
| | 1-naphthol | | |

(b). Alkalizing Agent

The oxidative dye composition may also contain one or more alkalizing agents preferably in a range of about 0.1-5% based on the total weight of the oxidative dye composition. The term “alkalizing agent” means an ingredient that is capable of imparting alkalinity (e.g. a pH of greater than 7) to the dye mixture. Suitable alkalizing agents include ammonium hydroxide, metal hydroxides, alkanolamines, sodium silicate, metal carbonates, sodium metasilicate, and mixtures thereof. Suitable metal hydroxides and carbonates include alkali metal and alkaline earth metal hydroxides or carbonates. Examples of such metal hydroxides include sodium, potassium, lithium, calcium, magnesium and so on. A particularly preferred alkaline earth metal hydroxide is sodium hydroxide. Suitable alkanolamines include mono-, di-, and trialkanolamines such as monoethanolamine (MEA), diethanolamine (DEA), triethanolamine (TEA), 2-aminobutanol, aminoethyl propanediol, aminomethyl propanediol, bis-hydroxyethyl tromethamine, diethanolamine, diethyl ethanolamine, diisopropanolamine, dimethylamino methylpropanol, dimethyl MEA, isopropanolamine, methylethanolamine, mixed isopropanolamines, triisopropanolamine, tromethamine, and mixtures thereof. A particularly preferred alkanolamine is MEA.

The alkalizing agent present in the hair dye mixture may react with other ingredients in the mixture in situ, such as fatty acids, proteins or hydrolyzed proteins, and the like. Depending on the amount of alkalizing agent present and the presence or absence of ingredients that will react with the alkalizing agent, it is possible that the alkalizing agent may be completely reacted in situ, partially reacted in situ, or not reacted at all if there are no other ingredients in the composition that will react with the alkalizing agent. Most preferred is where the oxidative dye composition comprises mixtures of alkalizing agents, in particular, ammonium hydroxide in combination with a second alkalizing agent such as an alkanolamine.

(c). Other Ingredients

(i). Fatty Acids

The composition may contain one or more fatty acids, and if so suggested ranges are about 0.001-15%, preferably 0.005-10%, most preferably 0.01-8% by weight of the total composition. If fatty acids are present they will react with the alkalizing agent to form soap in situ, which provides a more shampoo-like character to the aqueous hair color composition once it is applied to hair. Such fatty acids are of the general formula RCOOH wherein R is a straight or branched chain, saturated or unsaturated C₆₋₃₀ alkyl. Examples of suitable fatty acids include oleic acid, stearic acid, myristic acid, linoleic acid, and so on. Particularly preferred is oleic acid.

(ii). Conditioners

The oxidative dye composition may comprise one or more conditioners that exert a conditioning effect on hair. Conditioners mentioned above with respect to the developer composition are suitable, in the percentage ranges set forth.

(iii). Surfactants

Surfactants may also be used in the oxidative dye compositions of the invention. Suitable surfactants include nonionic, anionic, amphoteric, zwitterionic, and the like as set forth with respect to the developer composition and in the same percentage ranges.

(iv). Thickening Agents

Preferably the oxidative dye composition contains one or more thickening agents that increase the viscosity of the composition such that when it is applied to hair it doesn't run. The amount of thickening agent, if present, ranges from about 0.001-5%, preferably about 0.005-4%, more preferably about 0.005-3% by weight of the total composition.

A variety of thickening agents are suitable, including those set forth above with respect to the developer composition and in the same percentage ranges.

(v). Solvents

It may be desirable to include one or more solvents in the dye composition. Such solvents assist in solubilizing the primary intermediate dyestuff and coupler dyestuff components, in addition to the other ingredients in the composition. The solvent is preferably present at about 0.01-10%, preferably 0.05-8%, more preferably 0.1-7% by weight of the total composition. Suitable solvents include those referred to as humectants with respect to the developer composition and in the same general ranges, as well as alkoxydiglycols such as ethoxydiglycol and monohydric alcohols, such as isopropanol. The preferred solvent comprises ethoxydiglycol.

(vi) Chelating Agents

Preferably, the oxidative dye composition contains one or more chelating agents that are capable of chelating the metal ions found in water. If water contains too many extraneous metal ions they can interfere with the coloration process. Preferred ranges of chelating agent are 0.001-5%, preferably 0.005-4%, more preferably 0.01-3% by weight of the total composition. Preferred chelating agents are EDTA, HEDTA, and sodium or potassium salts thereof, as set forth with respect to the developer composition.

(vii). Antioxidants and Preservatives

The oxidative dye composition may also contain one or more antioxidants such as BHA, BHT, sodium sulfite, erythorbic acid and so on. Suggested ranges are from about 0.001-5%, preferably 0.005-4%, more preferably about 0.01-3% by weight of the total oxidative dye composition. Preservatives may also be incorporated into the oxidative dye composition.

C. The Diluent

The kit contains at least one receptacle containing the diluent, an aqueous based composition suitable for diluting the oxidative dye mixture that is formed by combining the developer and oxidative dye composition.

1. The Diluent Receptacle

The diluent 6 is found in a receptacle within the kit 1. The diluent receptacle 7 may be a bottle, jar, or any other type of container that is suitable for containing the aqueous based composition. Shown in FIG. 1 is where the diluent receptacle 7 is a bottle with a screw cap 8. The screw cap 8 contains threads on the inner cap surface that mate with corresponding threads on the neck of diluent receptacle 7. A variety of other caps or lids may be used to close diluent receptacle 7.

If desired, diluent receptacle 7 may contain an indicator line printed or embossed on the outer surface thereof 9. In the method and kit of the invention, the hair dye mixture must be diluted. This can be accomplished in a variety of ways, either by pouring the diluent into the receptacle containing the hair dye mixture or by pouring the hair dye mixture from the receptacle where it is stored into the diluent receptacle. In either case, indicator lines or markings on the receptacles will show the proportion of the two compositions that must be combined to provide the proper diluted mixture for application to the hair during the last period of the oxidative dyeing procedure.

2. The Diluent Composition

The diluent composition is preferably an aqueous based composition that is suitable for diluting the oxidative hair dye mixture that is formed by combining the developer composition and the oxidative hair dye composition. The diluent composition comprises from about 0.1-100%, preferably from about 20-99%, more preferably from about 50-98% water. The diluent composition may also contain any one or more of the ingredients set forth for use in the developer composition and/or oxidative dye composition (including oxidative or semi-permanent dyes), and in the same general percentage ranges.

D. Other Kit Components

1. Hair Conditioner

(a). Receptacle

The kit may contain other items, such as a hair conditioner composition 10 designated F in FIG. 1. The hair conditioner composition 10 is used to condition hair after the oxidative dye process of the invention. The hair conditioner receptacle 11 shown in FIG. 1 is a tube, but other receptacles are suitable including but not limited to jars, bottles, packettes, and the like.

(b). Hair Conditioner Composition

The hair conditioner composition is also aqueous based and generally comprises from about 0.1-99%, preferably from about 0.5-95%, more preferably from about 1-90% by weight of the total composition of water, and from about 0.1-95%, preferably from about 2-90%, more preferably from about 5-95% by weight of the total composition of other ingredients like those mentioned herein with respect to the developer and oxidative dye composition and in the same percentage ranges.

2. Applicators

If desired, the kit 1 may contain various types of applicators for applying the hair dye mixture to the hair, including but not limited to those designated as E1, E2, and E3 in FIG. 1. In each case, the applicators can be affixed to the receptacle containing the hair dye mixture and used to apply that mixture to the hair.

The E1 applicator 11 comprises a sponge tip 12 through which the hair dye mixture diffuses when the applicator 11 is affixed to either receptacle B or D to apply the hair dye mixture or diluted hair dye mixture to the hair. Applicator 11 contains a screw cap 12A for affixing applicator 11 to the receptacle. The hair dye mixture travels through a channel in the screw cap 12 and out the sponge tip 12 as it is stroked across the hair strands. This type of applicator is further disclosed in U.S. patent application Ser. No. 11/426,367, filed Jun. 26, 2006, entitled Methods and Kits for Touching Up Hair Color, which is hereby incorporated by reference in its entirety.

The E2 applicator 13 comprises an expanded cap portion 14 with threads 15 that are operable to mate with similar threads found on the neck of the receptacle to which the cap is affixed. Cap portion 14 extends upwardly in a nozzle 16, which terminates in a brush tip 17. When the E2 applicator 13 is affixed to the receptacle the oxidative dye mixture may be dispensed from the receptacle through the nozzle 16 and brush tip 17 for application to the hair.

The E3 applicator 18 is in the form of an expanded cap portion 19 that extends upwardly in nozzle 20 having an orifice 21. Then applicator 18 is affixed to the desired receptacle, the hair dye mixture can be dispensed to the hair through the nozzle 20 orifice 21.

While these three types of applicators have been shown, the kit and method of the invention is not limited to the particular applicators set forth. Rather, any type of suitable applicator may be used so long as it is operable to apply hair dye and can be used with the various receptacles of the invention.

3. Gloves

It may be desired to include gloves in the kit so that the consumer may protect her hands during the hair dye mixture application process.

4. Instructions

Also suitable for inclusion in the kit are instructions and other types of printed or graphic material.

5. Shampoo

It may also be desireable to include a container of shampoo for use in shampooing the hair after the coloring process.

### II. The Method

The invention further comprises a method for oxidatively coloring hair that exhibits at least two visually perceptible different colors wherein one of such colors is exhibited by virgin hair, comprising:

(a) combining an oxidative dye composition and a developer composition to form an oxidative dye mixture,

(b) applying a portion of the dye mixture selectively to the virgin hair for a certain period of time,

(c) diluting the remaining portion of the oxidative dye mixture with an aqueous based diluent to form a diluted oxidative dye mixture,

(d) applying the diluted oxidative dye mixture to the remaining prior colored hair for a certain period of time. The term “virgin hair” when used herein, means hair that has not previously been treated with oxidative dye. For example, in the case where gray hair is being dyed, the virgin hair is gray and includes hair roots with the remaining non-virgin hair being generally the color applied in the previous oxidative dye procedure. In another example, the user may have had virgin dark hair (such as black or brown), and had previously oxidatively colored the hair a lighter color such as blonde. In this case the virgin hair would include grown out dark roots with the remaining hair being the color applied in the previous oxidative dye procedure. In yet another example, the user may have had lighter hair, such as blonde, and oxidatively colored it a darker color such as brown or black. In this case the virgin hair would be blonde grown out roots and the remaining hair would be the darker color of the previously applied oxidative dye.

1. Application Step One of Dyeing Process

In the method of the invention, appropriate amounts of the developer composition and oxidative dye composition are combined to form the oxidative dye mixture. More preferably, from about 1 to 3 parts of the developer composition is combined from about 1 to 3 parts of the oxidative dye composition. In one of the most preferred embodiments, about 1.5 parts of the developer composition is combined with about 1 part of the oxidative dye composition. In one embodiment, the oxidative dye composition found in receptacle 5 is added to the developer composition 3 as found in receptacle B. The mixture is shaken. Then user then applies a portion of the hair dye mixture to the desired hair, generally the virgin hair, preferably by removing the screw cap 4 from the developer receptacle B and affixing one of E1, E2, E3, or similar caps to the developer receptacle B. The amount of mixture applied to the hair in step 1 is generally the amount the remains in the receptacle at indicator line 3A. That is, the oxidative dye mixture that is in the receptacle is applied to the desired areas of the hair until the level of mixture in the container is at indicator line 3A. Indicator line 3A indicates to the consumer that when the hair dye mixture level reaches the line of demarcation, the remaining hair dye mixture should be saved for the dilution step, further described below.

The hair dye mixture is applied to the roots of the hair or faded hair strands of the virgin hair for about 5-65 minutes.

2. Dilution

The oxidative dye mixture in the receptacle is then diluted with the diluent. In the case where the oxidative dye mixture was mixed and stored in the developer bottle B, a second indicator line 3B may be found on the bottle B which shows the user how much of the diluent 9 found in the diluent receptacle D should be added to the dye mixture to provide a properly diluted mixture for the final application step. To simplify the process for the consumer, the amount of diluent present in receptacle D should be exactly the right amount to dilute the oxidative dye mixture to indicator line 3B.

It is also possible to mix the oxidative dye and developer composition by adding the oxidative dye composition 5 to the developer 3, and applying a portion mixture to the hair for the appropriate period of time. The appropriate amount of oxidative dye mixture to be applied to the hair in the first step is determined by demarcation line 3A on the developer receptacle B. Then, rather than adding the diluent to the developer 3, it is possible to add the oxidative dye mixture to the diluent receptacle D. In this case, the diluent receptacle D will preferably contain an indicator line 9A that will indicate how much of the oxidative dye mixture should be added to obtain the proper dilution of the mixture for the final application process. In the case where the oxidative dye mixture is added to the diluent receptacle D, any one or more of caps E1, E2, E3, or any other cap may be used to affix to diluent receptacle D to apply the final diluted mixture to the hair.

The oxidative dyeing process of the invention is in at least two steps. In the first step, the oxidative dye composition and developer are combined as noted above and applied to the desired hair strands. In the case where the hair has been previously oxidatively dyed, a portion of the mixture may be applied to the new hair growth and any faded or discolored strands. Typically, the mixture is applied to the hair for anywhere from 5 to 60 minutes, preferably from about 8 to 45 minutes, more preferably from about 10-35 minutes. Then, the user dilutes the remaining oxidative dye mixture using the diluent to form a diluted mixture which is applied to the entire head of hair for a period of time ranging from about 1 to 20, preferably from about 2 to 15, more preferably from about 3 to 10 minutes. The mixture is then completely rinsed from the hair. If desired other post oxidative treatment products can be applied such as shampoo, hair conditioner, color glaze, and the like.

The method and kit of the invention provide users with a way to effectively color hair that has at least two visually perceptible different colors, where the end-resulting color is more homogeneous and less dependent upon the color of the base hair shade. The method and kit of the invention are also very effective in coloring hair that is oxidatively dyed on a regular basis and where the new hair growth and/or faded hair strands are gray and the remaining color is the color that the hair was oxidatively dyed in the prior process. The process is also effective for users who desire to color hair in a salon quality process where the roots having one color are colored first followed by coloring the remaining hair which is already colored a different color.

In general, the method and process of the invention provide an oxidative hair color kit and method where the color of the hair at the beginning of the procedure does not affect the quality of the coloration.

The invention will be further described in connection with the following examples, which are set forth for the purposes of illustration only.

### EXAMPLE 1

Aqueous based diluent compositions were prepared as follows:

| Ingredient | A | B | C |
|---|---|---|---|
| Water | QS | QS | QS |
| Hydroxyethylcellulose | — | — | 0.75 |
| Tetrasodium EDTA | 0.30 | 0.30 | 0.25 |
| Sodium laureth sulfate | 20.00 | 20.00 | 10.00 |
| Sodium lauryl sulfate | 10.00 | 5.00 | — |
| Cocamidopropyl betaine | 4.00 | 5.00 | — |
| Cocamide MEA | 2.00 | 2.00 | — |
| Glycol distearate | — | 0.50 | — |
| Monoethanolamine | 1.150 | 0.09 | — |
| Isostearic acid | 2.50 | — | — |
| Polyquaternium-10 | — | — | 0.10 |
| Fragrance | 0.20 | 0.20 | 0.20 |
| Sodium chloride | — | 1.00 | — |

The diluent compositions were prepared by combining the ingredients and mixing well. They were stored in bottles.

While the invention has been described in connection with the preferred embodiment, it is not intended to limit the scope of the invention to the particular form set forth but, on the contrary, it is intended to cover such alternatives, modifications, and equivalents as may be included within the spirit and scope of the invention as defined by the appended claims.

We claim:

1. A kit for oxidatively coloring hair comprising at least one receptacle containing an oxidative dye composition, at least one receptacle containing a developer composition, wherein the oxidative dye composition and the developer are mixed to form an oxidative dye mixture, and at least one receptacle containing an aqueous based diluent for the oxidative dye mixture.

2. The kit of claim 1 wherein the oxidative dye composition is found in a tube.

3. The kit of claim 1 wherein the developer composition is found in a plastic receptacle.

4. The kit of claim 1 wherein the receptacle containing the aqueous based diluent is a plastic.

5. The kit of claim 1 wherein the receptacle containing the developer composition contains a first indicator line.

6. The kit of claim 5 wherein the receptacle contains a second indicator line.

7. The kit of claim 1 further containing at least one applicator for the oxidative dye mixture.

8. The kit of claim 1 wherein the receptacle containing the diluent contains a first indicator line.

9. The kit of claim 1 wherein the oxidative dye composition found in its receptacle is added to the receptacle containing the developer composition to form an oxidative dye mixture.

10. The kit of claim 5 wherein the first indicator line on the developer receptacle indicates how much oxidative dye mixture is applied to the hair in the first step of the coloring process.

11. The kit of claim 6 wherein the second indicator line on the developer receptacle indicates how much diluent from the diluent receptacle is added to the developer receptacle to properly dilute the oxidative dye mixture to be used in the second step of the coloring process.

12. A method for coloring hair using the kit of claim 1 comprising:
(a) combining the oxidative dye composition and the developer composition to form the oxidative dye mixture,
(b) applying a portion of the dye mixture selectively to virgin hair for a certain period of time,
(c) diluting a remaining portion of the oxidative dye mixture with the aqueous based diluent to form a diluted oxidative dye mixture,
(d) applying the diluted oxidative dye mixture to the remaining hair for a certain period of time.

13. The method of claim 12 wherein the virgin hair is gray hair.

14. The method of claim 12 wherein the virgin hair is grown out hair roots or faded or discolored strands of hair, and the oxidative dye mixture is applied to the roots of the hair or faded or discolored strands of hair for a period of 5 to 60 minutes.

15. The method of claim 14 wherein the diluted oxidative dye mixture is then applied to the entire head of hair for a period of time ranging from about 1 to 20 minutes.

16. The method of claim 12 wherein the oxidative dye mixture is rinsed from the hair with water.

17. The method of claim 16 wherein the oxidatively dyed hair is treated with hair conditioner.

18. The method of claim 12 that is used to color hair that has been previously oxidatively dyed.

19. The method of claim 18 wherein the hair that was previously oxidatively dyed exhibited virgin hair that was gray.

20. The method of claim 19 wherein the hair that was previously oxidatively dyed has virgin hair growth at the roots which is gray.
